(19) United States
(12) Patent Application Publication
(10) Pub. No.: US 2008/0282666 A1
(43) Pub. Date: Nov. 20, 2008

(54) Composite rope structures and systems and methods for fabricating cured composite rope structures

(76) Inventor: Chia-Te Chou, Bellingham, WA (US)

Correspondence Address: SCHACHT LAW OFFICE, INC., SUITE 202, 2801 MERIDIAN STREET, BELLINGHAM, WA, 98225-2412, US

(21) Appl. No.: 12/154,074

(22) Filed: May 19, 2008

Related U.S. Application Data
(60) Provisional application No. 60/931,088, filed on May 19, 2007.

(51) Int. Cl. D02G 3/36; B28B 7/22; B63B 21/00

(52) U.S. Cl. 57/297; 264/255; 114/254

(57) ABSTRACT

A method of fabricating a composite rope structure comprising the following steps. Impregnated yarns comprising fibers within a resin matrix are fabricated at a first location. The impregnated yarns are transported from the first location to a second location. The impregnated yarns are dispensed at the second location. The resin matrix of the dispensed impregnated yarns is cured at the second location to obtain the composite rope structure.

### RELATED APPLICATIONS

This application claims priority of U.S. Provisional Patent Application Ser. No. 60/931,088 filed May 19, 2007, the contents of which are incorporated herein by reference.

### TECHNICAL FIELD

The present invention relates to composite rope structures and, in particular, to systems and methods for fabricating cured composite rope structures.

### BACKGROUND

The need often exists for a rope structure to be arranged in tension between two objects. The characteristics of a given type of rope structure determine whether that type of rope structure is suitable for a specific intended use. Characteristics of rope structures include breaking strength, elongation, flexibility, weight, and surface characteristics such as abrasion resistance and coefficient of friction. Additionally, environmental factors such as heat, cold, moisture, UV light, bending, abrasion, and the like may affect the characteristics of a rope structure.

The intended use of a rope thus typically determines the acceptable range for each characteristic of the rope. The term “failure” as applied to rope will be used herein to refer to a rope being subjected to conditions beyond the acceptable range associated with at least one rope characteristic.

Composite rope structures have been proposed for certain environments. Composite rope structures comprise fibers arranged within a resin matrix. The resin may be cured or uncured: when uncured, the resin is plastic or malleable; when cured, the resin is no longer flexible, and a cured composite rope structure is relatively rigid.

One environment in which the characteristics of a composite rope structure may be desirable is a deepwater drilling system. The present invention will be described below in the context of a mooring system for a deepwater drilling system, but the principles of the present invention may be employed in other environments in which the characteristics of composite rope structures may be desirable.

The need thus exists for improved composite rope structures and in particular for systems and methods for producing and deploying composite rope structures.

### SUMMARY OF THE INVENTION

The present invention may be embodied as a method of fabricating a composite rope structure comprising the following steps. Impregnated yarns comprising fibers within a resin matrix are fabricated at a first location. The impregnated yarns are transported from the first location to a second location. The impregnated yarns are dispensed at the second location. The resin matrix of the dispensed impregnated yarns is cured at the second location to obtain the composite rope structure.

The present invention may also be embodied as a method of fabricating a composite rope structure comprising the following steps. Impregnated yarns comprising fibers within a resin matrix are fabricated at a first location. The impregnated yarns are collected on a plurality of yarn bobbins. The impregnated yarns on the plurality of yarn bobbins are combined at the first location to obtain uncured strands. The uncured strands are collected on a plurality of strand bobbins. The uncured strands on the plurality of strand bobbins are combined at the first location to obtain an uncured rope structure. The uncured rope structure is collected on a rope bobbin. The uncured rope structure collected on the rope bobbin is transported from the first location to a second location. The uncured rope structure is dispensed at the second location by removing the uncured rope structure from the rope bobbin. The resin matrix is cured at the second location to obtain the composite rope structure.

The present invention may also be embodied as a system for fabricating a composite rope structure comprising a twisting system, a first release agent stage, a first combining system, a second release agent stage, and a second combining system. The twisting system twists fibers within a resin matrix to obtain impregnated and twisted yarns. The first release agent stage applies release agent to the impregnated and twisted yarns. The first combining system combines the impregnated and twisted yarns to obtain uncured strands. The second release agent stage applies release agent to the uncured strands. A second combining system combines the uncured strands to obtain the composite rope structure

The present invention may also be embodied as a system for deploying a composite rope structure comprising a rope bobbin, a heating element, and a shaping die. The rope bobbin supports an uncured rope structure comprising fibers and a resin matrix. The heating element heats the uncured rope structure such that the uncured resin matrix cures. The shaping die engages the uncured rope structure to maintain the uncured rope structure in a desired geometry as the resin matrix cures.

The present invention may also be embodied as a system for fabricating and deploying a composite rope structure comprising a fabricating system at a first location and a deploying system at a second location. The fabricating system comprises a twisting system and first and second combining systems. The twisting system twists fibers within a resin matrix to obtain impregnated yarns. The first combining system combines uncured yarns to obtain uncured strands. The second combining system combines the uncured strands to obtain the uncured rope structure. The deploying system comprises a rope bobbin, a heating element, and a shaping die. The rope bobbin supports an uncured rope structure comprising fibers and a resin matrix. The heating element heats the uncured rope structure such that the uncured resin matrix cures. The shaping die engages the uncured rope structure to maintain the uncured rope structure in a desired geometry as the resin matrix cures.

### BRIEF DESCRIPTION OF THE DRAWINGS

FIG. 1 is a somewhat schematic view of a deepwater drilling system employing a cured composite rope structure of the present invention;

FIG. 2 is a somewhat schematic view of a portion of the deepwater drilling system of FIG. 1 further depicting an onsite curing system used to cure the uncured composite rope structure according to the principles of the present invention;

FIG. 3 is a highly schematic view of an example twisting system used as part of the process of fabricating the cured composite rope structure depicted in FIGS. 1 and 2;

FIG. 4 is a highly schematic view of a first combination system that may be used as part of the process of fabricating the cured composite rope structure depicted in FIGS. 1 and 2;

FIG. 5 is a highly schematic view of a second combination system that may be used as part of the process of fabricating the cured composite rope structure depicted in FIGS. 1 and 2; and

FIG. 6 is a highly schematic view of the onsite curing system depicted in FIG. 2.

### DETAILED DESCRIPTION OF THE INVENTION

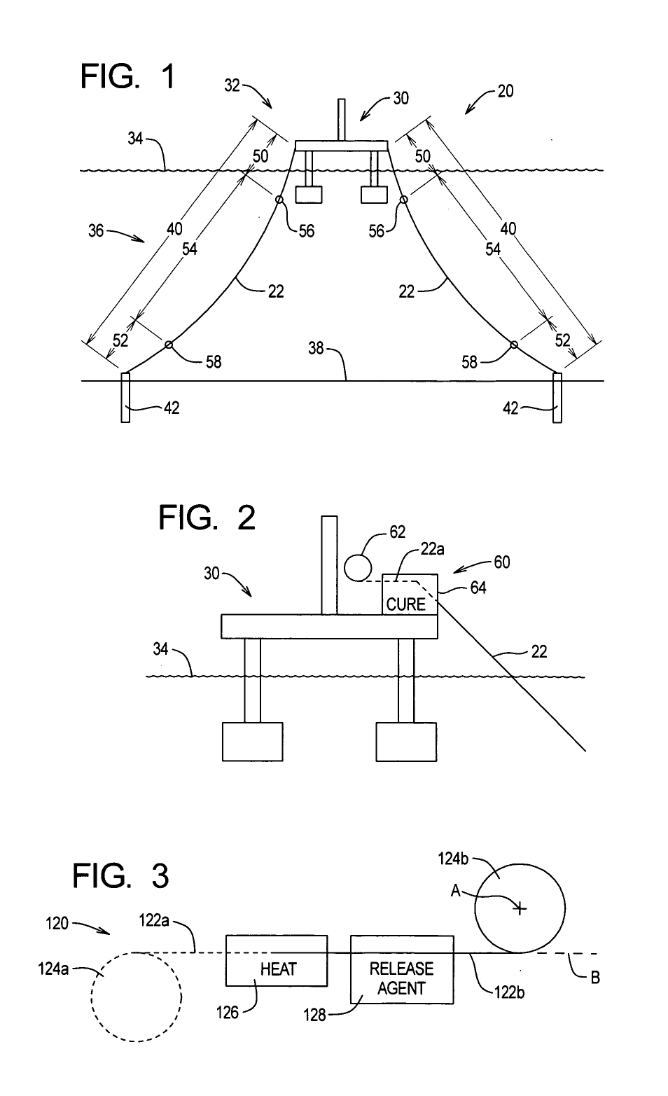

Referring initially to FIG. 1 of the drawing, depicted therein is a deepwater drilling system 20 employing one or more cured composite rope structures 22 fabricated according to the principles of the present invention. The deepwater drilling system 20 is not per se part of the present invention and will be described herein only to the extent necessary for a complete understanding of the present invention.

The deepwater drilling system 20 comprises a platform 30 secured at a desired location 32 on the ocean surface 34 by a mooring system 36 connected to the ocean floor 38. The mooring system 36 comprises a plurality of mooring lines 40 that extend in a radial pattern from the platform 30. The mooring lines 40 are secured to pilings 42 driven into the ocean floor 38. Each mooring line 40 is taut but has some flexibility and thus forms a catenary between the platform 30 and the ocean floor 38. While only two mooring lines 40 are depicted in FIG. 1, typically twelve anchor lines 40 are provided.

Each anchor line comprises a top section 50, a bottom section 52, and an intermediate section 54. The top sections 50 are coupled to the intermediate sections 54 by upper coupler assemblies 56, while the bottom sections 52 are coupled to the intermediate sections 54 by lower coupler assemblies 58. In the example mooring system 36, the intermediate sections 54 are formed by the cured composite rope structure 22 of the present invention.

Referring now to FIG. 2 of the drawing, depicted therein is an onsite curing system 60 that is supported by the platform 30. The onsite curing system 60 comprises a rope bobbin 62 and a curing assembly 64. The rope bobbin 62 stores an uncured (or partly cured) composite rope structure 22a. The uncured composite rope structure 22a is unwound from the rope bobbin 62 and passed through the curing assembly 64 to form the cured composite rope structure 22.

In both the cured state 22 and uncured state 22a, the composite rope structure of the present invention comprises a plurality of fibers embedded within a matrix of resin, as will be described in further detail below. Examples of composite rope members in connection with which the present invention may be used are described in the Applicant's copending U.S. Patent Application Ser. Nos. 60/930,853 (Attorney Matter No. P215308) and 60/931,089 (Attorney Matter No. P215422).

In the uncured state 22a, the resin matrix is uncured and is thus malleable or plastic. The uncured composite rope structure 22a is flexible, allowing it to be wound onto and unwound from the rope bobbin 62. In the cured state 22, the resin is cured and no longer malleable or plastic. Accordingly, the cured composite rope structure 22 is sufficiently rigid that it cannot be wound onto the rope bobbin 62.

By supporting the curing system 60 on the platform 30, the uncured composite rope structure 22a may be stored and transported in rolled form on one or more rope bobbins 62. The rope bobbins 62 can hold thousands of feet of the uncured composite rope structure 22a in easily manageable packages. Then, immediately prior to deployment, the uncured composite rope structure 22a is passed through the curing assembly 64 and cured into the relatively rigid cured composite rope structure as depicted in FIGS. 1 and 2. The cured composite rope structure 22 thus may be engineered to function as one or more of the intermediate sections 54 of the anchor lines 40.

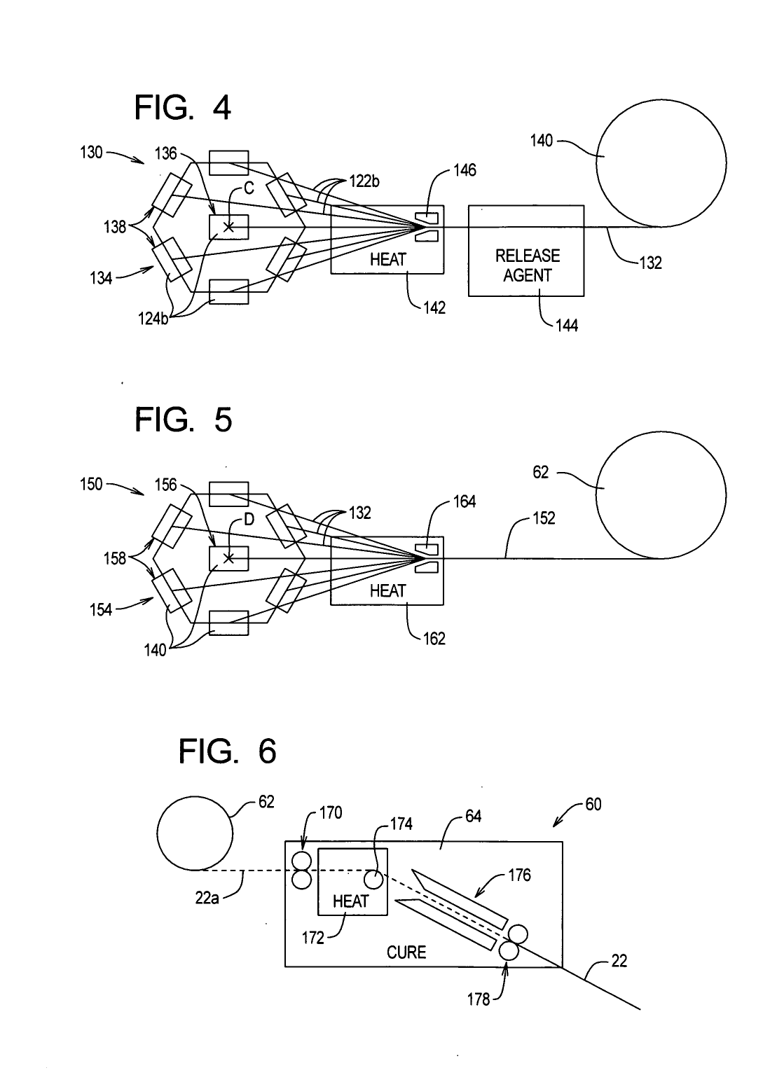

Referring now to FIGS. 3-6 of the drawing, one example of the process of fabricating an example uncured composite rope structure 22a and then curing the uncured composite rope structure 22a to form the example cured composite rope structure 22 will now be described in detail. The process of manufacturing the example cured composite rope structure 22 comprises a twisting step depicted in FIG. 3, a first combination step depicted in FIG. 4, a second combination step depicted in FIG. 5, and a curing step depicted in FIG. 6. The twisting step, first combination step, and second combination step will be performed at a dedicated manufacturing facility, while the curing step will be performed onsite as depicted, for example, in FIG. 2.

Referring first to FIG. 3, depicted therein is a twisting system 120 for twisting impregnated yarns 122; the impregnated yarns 122 are identified in their untwisted state by reference character 122a and in their twisted state by reference character 122b. The use of broken lines in FIGS. 2-6 indicates that the resin matrix is uncured, while the use of solid lines indicates that the resin matrix is cured.

The impregnated yarns 122 are composite structures comprising fibers and resin. The fibers are primarily responsible for the strength properties of the yarns 122 under tension loads. The resin forms a matrix of material that surrounds the fibers and transfers loads between the fibers. The resin matrix further protects the fibers from the surrounding environment. As examples, the resin matrix can be formulated to protect the fibers from heat, abrasion, UV, and other external environmental factors.

The example resin portion of the impregnated yarns 122 exists in an uncured state and a cured state. In the uncured state, the resin material is flexible, and the matrix allows the impregnated yarns 122 to be bent, twisted, and the like. In general, the resin matrix becomes more plastic or malleable when heated, up to a cure temperature. Above the cure temperature, the resin matrix cures and becomes substantially more rigid. The properties of the resin matrix can be adjusted for manufacturing convenience and/or for a particular intended operating environment of the final composite rope structure.

The example impregnated yarns 122 comprise approximately 90% by weight of fibers and approximately 10% by weight of resin. The fibers may be in a first range of substantially between 85% and 95% by weight of the yarn but in any event should be within a second range of substantially between 70% and 98% by weight of the yarn. The resin may be in a first range of substantially between 5% and 15% by weight of the yarn but in any event should be within a second range of substantially between 1% and 30% by weight of the yarn. Other combinations of resin and fibers can be used to implement the principles of the present invention.

In particular, another example of the impregnated yarns 122 comprises approximately 80% by weight of fibers and approximately 20% by weight of resin. The fibers may be in a first range of substantially between 75% and 90% by weight of the yarn but in any event should be within a second range of substantially between 50% and 95% by weight of the yarn. The resin may be in a first range of substantially between 10% and 25% by weight of the yarn but in any event should be within a second range of substantially between 5% and 50% by weight of the yarn.

The example fibers are glass fibers but may be one or a combination of carbon fibers, aramid fibers, polyester fibers, HMPE, basalt, Vectran, PBO, PBI, and ceramic fibers. The resin is a thermoplastic polyurethane, but other thermoplastic materials or the combination of thermoplastic and thermosetting resin systems may also be used. Other suitable thermoplastic materials include polyester, polyethylene, polypropylene, nylon, PVC, and their mixtures may also be used. Other compositions of resins and fibers can be used to implement the principles of the present invention.

The example twisting system 120 comprises a first bobbin 124a for storing the untwisted impregnated yarns 122a and a second bobbin 124b for storing the twisted impregnated yarns 122b. The untwisted impregnated yarn 122a is unwound from the first bobbin 124a, twisted, and taken up on the second bobbin 124b as the twisted impregnated yarn 122b.

In the example twisting system 120, the second bobbin 124b rotates about a primary axis of rotation A and also rotates about a twist axis of rotation B defined by the impregnated yarn 122. The rotation of the second bobbin 124b about the primary axis A and the twist axis B converts the untwisted impregnated yarn 122a into the twisted impregnated yarn 122b and winds the twisted impregnated yarn 122b on the second bobbin 124b. Where the fibers forming the untwisted impregnated yarn 122a are substantially straight and parallel, the fibers forming the twisted impregnated yarn 122b take on a generally helical configuration.

The untwisted impregnated yarn 122a may be twisted at room temperature. However, to facilitate the twisting process, the twisting system 120 further optionally comprises a heating stage 126 for heating the untwisted impregnated yarns 122a before, as, and/or after they are twisted. The heating stage 126 increases the temperature of the resin matrix of the untwisted impregnated yarns 122a to a temperature that is elevated but below the cure temperature of the resin matrix.

By softening the resin forming the matrix portion of the untwisted impregnated yarns 122a, the fibers can more easily be twisted into the substantially helical configuration. Also, when preheated prior to, as, and/or after they are twisted and then allowed to cool, the resin matrix portion of the twisted impregnated yarns 122b is more likely to maintain the fibers in the substantially helical configuration.

The example twisting system 120 further optionally comprises a release agent stage 128 for applying a release agent to the twisted impregnated yarns 122b as they are taken up on the second bobbin 124b. The release agent or similar chemicals help to prevent the binding among the twisted impregnated yarns at the elevated temperature or when curing in the subsequent combination of the twisted impregnated yarns 122b with other rope components as will be described below.

FIG. 4 illustrates a first example combining system 130 for combining multiple uncured twisted impregnated yarns 122b into an uncured strand 132. The example strand 132 comprises seven twisted impregnated yarns 122b in what will be referred to as a 1×7 configuration. The twisted impregnated yarns 122b may, however, be combined using fewer or more yarns and in combination structures other than a 1×7 configuration.

To form the example strand 132, seven of the second bobbins 124b are supported by a first rotator assembly 134. The first rotator assembly 134 is or may be conventional and will be described herein only as necessary for a complete understanding of the present invention. The example first rotator assembly 134 comprises a central bobbin mount 136 and a six perimeter bobbin mounts 138. The central bobbin mount 136 allows the second bobbin 124b supported thereon to rotate about its primary axis A. The second bobbins 124b are supported by the perimeter bobbin mounts 138 for rotation about their primary axes A.

The perimeter bobbin mounts 138 further support the second bobbins 124b for rotation together about a system axis C defined by the first rotator assembly 134. The central bobbin mount 136 may be supported with the perimeter bobbin mounts 138 such that the second bobbin 124b supported thereby also rotates about the system axis C with the second bobbins 124b supported at the perimeter bobbin mounts 138. Alternatively, the central bobbin mount 136 may be supported independent of the perimeter bobbin mounts 138 such that the second bobbin 124b supported thereby rotates only about its primary axis A and not about the system axis C.

As the twisted impregnated yarns 122b are withdrawn from the first rotator assembly 134, the twisted impregnated yarns 122b unwound from the second bobbins 124b at the perimeter bobbin mounts 138 are combined with the twisted impregnated yarn 122b unwound from the second bobbin mount 124b at the central bobbin mount 136 to form the strand 132. In the example system 130, the strand 132 is taken up on a strand bobbin 140.

The twisted yarn 122b unwound from the second bobbin mount 124b at the central bobbin mount 136 forms a core impregnated yarn of the strand 132. The fibers in the core impregnated yarn maintain the substantially helical configuration created by the twisting system 120. The twisted impregnated yarns 122b around core yarn will be referred to as the perimeter yarns. The fibers in the perimeter yarns maintain the substantially helical configuration created by the twisting system 120 but will also have a secondary helical configuration centered about the core yarn. The fibers in the perimeter yarns thus have a substantially double helical configuration.

The twisted impregnated yarns 122b may be combined to form the strand 132 at room temperature. However, to facilitate the combination process, the first combination system 130 further optionally comprises a heating stage 142 for heating the twisted impregnated yarns 122b before and/or as they are combined. The heating stage 142 increases the temperature of the resin matrix of the twisted impregnated yarns 122b to a temperature that is elevated but below the cure temperature of the resin matrix.

By softening the resin forming the matrix portion of the twisted impregnated yarns 122b, the twisted impregnated yarns 122b can more easily be combined into the strands 132 with fibers of the core yarns in the substantially helical configuration and the fibers in perimeter yarns in the substantially double helical configuration. Also, when preheated prior to, as, and/or after they are twisted and then allowed to cool, the resin matrix portion of the twisted impregnated yarns 122b is more likely to maintain the fibers of the core impregnated yarn in the helical configuration and the fibers in the perimeter impregnated yarns in the substantially double helical configuration.

The example combination system 130 further optionally comprises a release agent stage 144 for applying a release agent to the strand 132 as it is are taken up on the strand bobbin 140. The release agent or similar chemicals help to prevent the binding among the strands 132 at the elevated temperature or when curing in the subsequent combination of the strand 132 with other rope components as will be described below.

The example second combination system 130 further comprises an optional shaping die 146. The shaping die 146 is arranged where the ends are twisted and joined together.

FIG. 5 illustrates a second combining system 150 for combining multiple strands 132 into a rope structure 152. The example rope structure 152 comprises seven strands 132 in what will be referred to as a 7×7 configuration. The strands 132 may, however, be combined using fewer or more yarns and in combination structures other than a 7×7 configuration.

To form the example rope structure 152, seven of the strand bobbins 140 are supported by a second rotator assembly 154. The second rotator assembly 154 is or may be conventional and will be described herein only as necessary for a complete understanding of the present invention. The example second rotator assembly 154 comprises a central bobbin mount 156 and a six perimeter bobbin mounts 158. The central bobbin mount 156 allows the strand bobbin 140 supported thereon to rotate about its primary axis. The strand bobbins 140 supported by the perimeter bobbin mounts 158 are supported for rotation about their primary axes.

The perimeter bobbin mounts 158 further support the strand bobbins 140 for rotation together about a system axis D defined by the second rotator assembly 154. The central bobbin mount 156 may be supported with the perimeter bobbin mounts 158 such that the strand bobbin 140 supported thereby also rotates about the system axis D with the strand bobbins 140 supported at the perimeter bobbin mounts 158. Alternatively, the central bobbin mount 156 may be supported independent of the perimeter bobbin mounts 158 such that the strand bobbin 140 supported thereby rotates only about its primary axis and not about the system axis D.

As the strands 132 are withdrawn from the second rotator assembly 154, the strands 132 unwound from the strand bobbins 140 at the perimeter bobbin mounts 158 are combined with the twisted impregnated strand 132 unwound from the strand bobbin 140 at the central bobbin mount 156 to form the rope structure 152. In the example system 130, the rope structure 152 is taken up on a rope bobbin 62 described above.

The strand 132 unwound from the strand bobbin 140 at the central bobbin mount 156 forms a core strand of the rope structure 152. The fibers in the core strand maintain the shape created by the first combination system 130. The strands 132 around core strand will be referred to as the perimeter strands. The fibers in the perimeter yarns of the perimeter strands maintain the shape created by the first combining system 130 but will also have a tertiary helical configuration centered about the core strand. The fibers in the perimeter yarns thus have a substantially triple helical configuration.

The strands 132 may be combined to form the rope structure 152 at room temperature. However, to facilitate the combination process, the second combination system 150 further optionally comprises a heating stage 162 for heating the strands 132 before, as and/or after they are combined. The heating stage 162 increases the temperature of the resin matrix of the strands 132 to a temperature that is elevated but below the cure temperature of the resin matrix.

By softening the resin forming the matrix portion of the strands 132, the strands 132 can more easily be combined into the strands 132 with fibers of maintaining the appropriate helical configurations. Also, when preheated prior to, as, and/or after they are twisted and then allowed to cool, the resin matrix portion of the strands 132 is more likely to maintain the fibers in the appropriate helical configurations.

The example second combination system 150 further comprises an optional shaping die 164. The shaping die 164 is arranged where the ends are twisted and joined together.

Referring now to FIG. 6, depicted therein in more detail is the onsite curing system 60 described above with reference to FIG. 2. The onsite curing system 60 was described above in the context of deploying anchor lines used by an deepwater drilling system 20, but the onsite curing system may be used to deploy cured composite rope structures in other environments, for other purposes, and at other locations.

The example curing assembly 64 is shown to comprise infeed rollers 170, a heating element 172, an intermediate roller 174, a shaping die 176, and outfeed rollers 178.

As the uncured composite rope structure 22a is unwound from the rope bobbin 62, the uncured composite rope structure 22a first passes through the infeed rollers 170. The infeed rollers 170 support and direct the uncured composite rope structure 22a as it is unwound from the rope bobbin 62.

The uncured composite rope structure 22a is next fed through the heating element 172. The heating element 172 is typically an elongate oven capable of raising the temperature of the resin matrix of the uncured rope structure 22a to above the cure temperature of the resin matrix. The heating element 172 may control the pressure and/or other environmental factors that may affect the curing of the resin matrix.

As the uncured rope structure 22a leaves the heating element 172, the temperature of the resin matrix has been elevated to above the cure temperature, which begins the chemical process that causes the resin matrix to cure. Some time may be required for the resin matrix to fully cure. Accordingly, the composite rope structure 22a is still identified as being in the uncured state as it leaves the heating element 172 in FIG. 6.

The uncured composite rope structure 22a leaving the heating element 172 is thus passed over the intermediate roller 174 to change the direction of the composite rope structure 22a. In the example shown in FIG. 6, the still uncured composite rope structure 22a is fed through shaping die 176 which maintains the rope structure 22a in a desired geometry and directs the rope structure 22a in a desired direction as the resin matrix fully cures. After passing through the shaping die 176, the composite rope structure is cured as indicated by the use of solid lines. The cured composite rope structure 22 is supported by outfeed rollers 178 as the rope structure 22 is deployed from the curing assembly 64.

Given the foregoing, it should be apparent that the present invention may be embodied in forms other than those described above. The scope of the present invention should be determined with reference to the claims appended hereto and not the foregoing detailed description of examples of the present invention.

What is claimed is:

1. A method of fabricating a composite rope structure comprising the steps of:
fabricating at a first location impregnated yarns comprising fibers within a resin matrix;
transporting the impregnated yarns from the first location to a second location;
dispensing the impregnated yarns at the second location; and
curing the resin matrix of the dispensed impregnated yarns at the second location to obtain the composite rope structure.

2. A method as recited in claim 1, further comprising the steps of combining the impregnated yarns at the first location to obtain uncured strands, where the step of transporting the impregnated yarns comprises the step of transporting the uncured strands from the first location to the second location.

3. A method as recited in claim 2, further comprising the steps of combining the uncured strands at the first location to obtain an uncured rope structure, where the step of transporting the impregnated yarns comprises the step of transporting the uncured rope structure from the first location to the second location.

4. A method as recited in claim 1, further comprising the step of twisting the fibers within the resin matrix of the impregnated yarns.

5. A method as recited in claim 1, further comprising the step of heating the impregnated yarns.

6. A method as recited in claim 4, further comprising the step of heating the impregnated yarns to facilitate twisting of the fibers within the resin matrix.

7. A method as recited in claim 2, further comprising the step of heating the impregnated yarns to facilitate combination of the impregnated yarns into the uncured strands.

8. A method as recited in claim 3, further comprising the steps of:
heating the impregnated yarns to facilitate combination of the impregnated yarns into uncured strands;
heating the uncured strands to facilitate combination of the uncured strands into the uncured rope structure.

9. A method as recited in claim 1, further comprising the step of applying a release agent to the uncured yarn.

10. A method as recited in claim 2, further comprising the steps of:
applying a release agent to the impregnated yarn; and
applying a release agent to the uncured strands.

11. A method as recited in claim 1, in which the step of curing the uncured rope structure comprises the step of heating the uncured rope structure.

12. A method as recited in claim 1, further comprising the step of shaping the uncured rope structure.

13. A method as recited in claim 1, further comprising the step of collecting the impregnated yarns on at least one yarn bobbin.

14. A method as recited in claim 2, further comprising the steps of:
collecting the impregnated yarns on at least one yarn bobbin; and
collecting the uncured strands on at least one strand bobbin.

15. A method as recited in claim 3, further comprising the steps of:
collecting the impregnated yarns on at least one yarn bobbin;
collecting the uncured strands on at least one strand bobbin; and
collecting the uncured rope structure on at least one rope bobbin.

16. A method as recited in claim 15, in which the step of transporting the impregnated yarn from the first location to a second location comprises the step of transporting the uncured rope structure collected on the at least one rope bobbin from the first location to the second location.

17. A method of fabricating a composite rope structure comprising the steps of:
fabricating at a first location impregnated yarns comprising fibers within a resin matrix;
collecting the impregnated yarns on a plurality of yarn bobbins;
combining the impregnated yarns on the plurality of yarn bobbins at the first location to obtain uncured strands;
collecting the uncured strands on a plurality of strand bobbins;
combining the uncured strands on the plurality of yarn bobbins at the first location to obtain an uncured rope structure;
collecting the uncured rope structure on a rope bobbin;
transporting the uncured rope structure collected on the rope bobbin from the first location to a second location;
dispensing the uncured rope structure at the second location by removing the uncured rope structure from the rope bobbin; and
curing the resin matrix at the second location to obtain the composite rope structure.

18. A method as recited in claim 17, further comprising the steps of:
heating the impregnated yarns to soften the resin matrix of the impregnated yarns;
twisting the fibers within the softened resin matrix of the impregnated yarns;
heating the impregnated yarns to facilitate combination of the impregnated yarns into the uncured strands;
heating the uncured strands to facilitate combination of the uncured strands into the uncured rope structure.

19. A method as recited in claim 2, further comprising the steps of:
applying a release agent to the impregnated yarns; and
applying a release agent to the uncured strands.

20. A method as recited in claim 17, in which the step of curing the uncured rope structure comprises the step of heating the uncured rope structure.

21. A method as recited in claim 17, further comprising the step of shaping the uncured rope structure.

22. A system for fabricating a composite rope structure, the fabricating system comprising:
a twisting system for twisting fibers within a resin matrix to obtain impregnated and twisted yarns;
a first release agent stage for applying release agent to the impregnated and twisted yarns;
a first combining system for combining impregnated and twisted yarns to obtain uncured strands;
a second release agent stage for applying release agent to the uncured strands; and
a second combining system for combining the uncured strands to obtain uncured composite rope.

23. A fabricating system as recited in claim 22, in which the twisting system comprises:
a first bobbin for storing untwisted impregnated yarns;
a heating stage for heating the untwisted impregnated yarns; and
a yarn bobbin for collecting the impregnated and twisted yarns, where the yarn bobbin rotates about a twist axis of rotation to twist the fibers within the resin matrix.

24. A fabricating system as recited in claim 22, in which the first combining system comprises:
a plurality of yarn bobbins;
a heating element;
a first shaping die; and
a strand bobbin; wherein
the plurality of yarn bobbins are rotated about a first system axis to combine the plurality of impregnated yarns into the uncured strands;
the first shaping die shapes the uncured strands; and
the strand bobbin collects the uncured strands.

25. A fabricating system as recited in claim 22, in which the second combining system comprises:
a plurality of strand bobbins;
a heating element;
a second shaping die; and
a rope bobbin; wherein
the plurality of strand bobbins are rotated about a second system axis to combine the plurality of uncured strands into the uncured rope structure;
the second shaping die shapes the uncured rope structure; and
the rope bobbin collects the uncured rope structure.

26. A system for deploying a composite rope structure, the deploying system comprising:
a rope bobbin for supporting an uncured rope structure comprising fibers and a resin matrix;
a heating element; and
a shaping die; wherein
the heating element heats the uncured rope structure such that the uncured resin matrix cures; and
the shaping die engages the uncured rope structure to maintain the uncured rope structure in a desired geometry as the resin matrix cures.

27. A deploying system as recited in claim 26, further comprising:
at least one infeed roller arranged to support the uncured rope structure extending from the rope bobbin to the heating element;
at least one intermediate roller arranged to support the uncured rope structure extending from the heating element to the shaping die; and
at least one outfeed roller arranged to support the uncured rope structure exiting the shaping die.

28. A system for fabricating and deploying a composite rope structure, the fabricating and deploying system comprising:
a fabricating system at a first location, the fabricating system comprising
a twisting system for twisting fibers within a resin matrix to obtain impregnated yarns,
a first combining system for combining impregnated yarns to obtain uncured strands, and
a second combining system for combining the uncured strands to obtain uncured composite rope; and
a deploying system at a second location, the deploying system comprising
a rope bobbin for supporting an uncured rope structure comprising fibers and a resin matrix,
a heating element, and
a shaping die, wherein
the heating element heats the uncured rope structure such that the uncured resin matrix cures, and
the shaping die engages the uncured rope structure to maintain the uncured rope structure in a desired geometry as the resin matrix cures.
